(19) United States
(12) Patent Application Publication
(10) Pub. No.: US 2024/0038424 A1
(43) Pub. Date: Feb. 1, 2024

(54) PREPARATION AND APPLICATION FOR A THIOL-FUNCTIONALIZED MAGNETIC OXYGENOUS CARBON NITRIDE NANOSHEET

(71) Applicant: Jiangsu University of Technology, Changzhou (CN)

(72) Inventors: Hongying LYU, Changzhou (CN); Shouqiang HUANG, Changzhou (CN); Xin LI, Changzhou (CN)

(73) Assignee: Jiangsu University of Technology, Changzhou (CN)

(21) Appl. No.: 18/225,162

(22) Filed: Jul. 24, 2023

(30) Foreign Application Priority Data
Jul. 26, 2022 (CN) 202210884940.6

(51) Int. Cl. H01F 1/16; B82Y 30/00; B82Y 40/00; C02F 1/28; C02F 1/62; C02F 1/48

(52) U.S. Cl. CPC H01F 1/16; B82Y 30/00; B82Y 40/00; C02F 1/288; C02F 1/62; C02F 1/488; C02F 2101/20

(57) ABSTRACT

A preparation method of a thiol-functionalized magnetic oxygenous carbon nitride nanosheet includes: dispersing carbon nitride oxide ultrasonically to obtain a carbon nitride oxide suspension; dissolving an iron source, and then adding it to the carbon nitride oxide suspension to obtain a first mixed solution; after an hydrothermal reaction of the first mixed solution, adjusting the pH value of the reaction system to be alkaline, and then cooling, separating the sediment, washing and drying to obtain a magnetic carbon nitride oxide composite; dispersing the magnetic carbon nitride oxide composite ultrasonically in a solvent, and then adding acid to adjust the pH to be acidic to obtain a second mixed solution; adding a thiol-rich modifier to the second mixed solution to modify the magnetic carbon nitride oxide composite; after modification, separating and washing the magnetic carbon nitride oxide composite from the solution to obtain a thiol-functionalized magnetic oxygenous carbon nitride nanosheet.

### CROSS REFERENCE TO THE RELATED APPLICATIONS

This application is based upon and claims priority to Chinese Patent Application No. 202210884940.6, filed on Jul. 26, 2022, the entire contents of which are incorporated herein by reference.

### TECHNICAL FIELD

The invention relates to the technical field of nano-carbon new materials and specifically relates to a preparation method and application of a thiol-functionalized magnetic oxygenous carbon nitride nanosheet.

### BACKGROUND

Heavy metal wastewater pollution has become one of the most serious and significant resource and environmental problems in the contemporary world with the continuous development of society and improper treatment of human beings. A large number of heavy metal pollutants are discharged into the environment, which has a serious impact on the biosphere. The sources of heavy metal pollutants are mainly some industrial and mining enterprises such as the electroplating industry, mining industry, metallurgical industry, petrochemical industry, and so on. Most heavy metals are highly toxic and difficult to degrade, they can accumulate in soil, atmosphere, and water, affect the entire ecosystem through the food chain, and then seriously endanger human health. Cadmium, as a heavy metal with high toxicity and carcinogenicity, mainly accumulates in the kidney. Long-term accumulation will lead to renal failure, osteomalacia, and osteoporosis, leading to cadmium poisoning ‘bone pain’. Lead does not have any physiological function and it is not required in the human body, therefore, when lead enters the human body with the biological chain, it will cause serious harm to the human body after exceeding a certain level, lead mainly affects the nervous system, and the intellectual damage caused by it is irreversible. Therefore, lead is particularly harmful to children. After lead poisoning, children's intellectual development and learning cognition will be affected, and in severe cases, they will become dementia. Arsenic has a strong accumulation in the human body, it will accumulate in the liver, kidney, and other parts of the human body, especially in the hair. It will induce skin cancer, lung cancer, and liver cancer when it exceeds a certain dose. Therefore, dealing with heavy metal wastewater is an urgent problem to be solved. At present, the methods for treating heavy metal wastewater can include biological flocculation, ion exchange, co-precipitation, electrochemical method, and adsorption method. These methods have their advantages and disadvantages. Among these treatment methods, the adsorption method has become an effective water purification technology because of its advantages of low treatment cost, simple and easy operation, good effect, and not easy to cause secondary pollution. The development of efficient adsorbents is the key to the treatment of heavy metal wastewater by adsorption. An ideal high-efficiency adsorbent should have high adsorption performance and mechanical strength, stable chemical properties, recyclability, and ease of separation from the solution. At present, adsorbents are divided into inorganic adsorbents, organic adsorbents, and carbonaceous adsorbents according to the chemical structure of the materials. Among them, raw materials of the inorganic adsorbent are cheap and easy to obtain, most of which are natural materials, generally with a large specific surface area and loose porous structure, which is conducive to the adsorption of heavy metal ions and dyes, including bentonite, fly ash, straw and so on. However, the adsorption effect of inorganic adsorbents is poor, the solid-liquid separation is difficult, and it is difficult to reuse. Most of the organic adsorbents are polymer organics. The materials themselves are artificially synthesized. Excessive use is easy to cause secondary pollution to the environment, easy to lose and degrade, and poor mechanical properties. Carbonaceous adsorbents are mainly composed of carbon elements. At present, activated carbon, graphene, carbon nanotubes, and so on are mostly used, but the high cost hinders their further application.

As a new two-dimensional material, the surface of oxygen-functionalized carbon nitride nanosheets is rich in a variety of active groups, such as amino, hydroxyl, and carboxyl groups. These active groups can not only provide good adsorption sites for heavy metal ions in wastewater but also provide active sites for chemical modification. In terms of cost, oxygen-functionalized graphite phase carbon nitride nanosheets have the advantages of easy availability of raw materials and low price compared with carbon nanotubes and fullerenes. Therefore, oxygen-functionalized carbon nitride nanosheets are expected to become industrial adsorbents. However, functional carbon nitride oxide, like other adsorbents, has the disadvantage of being difficult to separate from water after use. Therefore, in recent years, magnetic separation technology has become an emerging technology in the field of water treatment. This technology combines functionalized carbon nitride nanosheets with magnetic nanoparticles to prepare composite materials, thereby achieving the purpose of solid-liquid separation.

### SUMMARY

The purpose of the present invention is to provide a preparation method for a thiol-functionalized magnetic oxygenous carbon nitride nanosheet (CNO/Fe₃O₄—SH) in view of the problems raised in the background technology. The surface of the prepared thiol-functionalized magnetic oxygenous carbon nitride nanosheet contains a large number of active functional groups, which have the characteristics of a large specific surface area and easy preparation. Moreover, the composite material can be desorbed and reused after being applied to remove heavy metal ions in an aqueous solution, which solves the problem of difficult separation from the water body. At the same time, the nanosheet material has a good adsorption effect on heavy metal ions.

The invention is realized by the following technical solution:

A preparation method for a thiol-functionalized magnetic oxygenous carbon nitride nanosheet is characterized in that the method comprises the following steps:
1. preparation of a magnetic carbon nitride oxide composite:
S1, dispersing carbon nitride oxide ultrasonically to obtain a carbon nitride oxide suspension;
S2, dissolving an iron source, and then adding it to the carbon nitride oxide suspension to obtain a mixed solution A; among them: the iron source contains divalent iron and trivalent iron;
S3, after a hydrothermal reaction of the mixed solution A, adjusting the pH value of the reaction system to be alkaline, and then cooling, separating the sediment, washing, and drying to obtain a magnetic carbon nitride oxide composite;
2. preparation for the thiol-functionalized magnetic oxygenous carbon nitride nanosheet:
S1, dispersing the magnetic carbon nitride oxide composite ultrasonically in a solvent, and then adding acid to adjust the pH to be acidic to obtain a mixed solution B;
S2, adding a thiol-rich modifier to the mixed solution B to modify the magnetic carbon nitride oxide composite; after modification, separating and washing the magnetic carbon nitride oxide composite from the solution to obtain a thiol-functionalized magnetic oxygenous carbon nitride nanosheet (CNO/Fe₃O₄—SH).

Furthermore, a preparation method for a thiol-functionalized magnetic oxygenous carbon nitride nanosheet: 1, preparation of the magnetic carbon nitride oxide composite: Step S1, adding carbon nitride oxide to deionized water and dispersing ultrasonically for 3-5 hours to obtain a carbon nitride oxide suspension; among them: the mass volume ratio of the carbon nitride oxide to the deionized water is 20-60 mg/mL.

Furthermore, a preparation method for a thiol-functionalized magnetic oxygenous carbon nitride nanosheet: 1, preparation of the magnetic carbon nitride oxide composite: Step S2, dissolving the iron source in ultrapure water at room temperature to form a solution; then, adding the solution into the carbon nitride oxide suspension to obtain the mixed solution A; among them: the iron source is a mixture of ferric chloride hexahydrate and ferrous chloride tetrahydrate.

Furthermore, a preparation method for a thiol-functionalized magnetic oxygenous carbon nitride nanosheet: 1, preparation of the magnetic carbon nitride oxide composite: the mass volume ratio of iron source to ultrapure water described in Step S2 is 50-100 mg/mL; the volume ratio of the solution to the carbon nitride oxide suspension is 1:(2-5); the molar ratio of the ferric chloride hexahydrate to the ferrous chloride tetrahydrate is (1-3):1.

Furthermore, a preparation method for a thiol-functionalized magnetic oxygenous carbon nitride nanosheet: 1, preparation of the magnetic carbon oxide composite: Step S3, placing the mixed solution A in a water bath pot at 70-90° C. for 3-5 minutes, and then adding ammonia water quickly to adjust the pH value of the reaction system to 9-11, and then stirring reaction for 20-40 minutes, then cooling, separating and washing the sediments, drying at 50-70° C. for 12-24 hours to obtain the magnetic carbon oxide composite.

Furthermore, a preparation method for a thiol-functionalized magnetic oxygenous carbon nitride nanosheet: 2, preparation of the thiol-functionalized magnetic oxygenous carbon nitride nanosheet: Step S1, dispersing the magnetic carbon nitride oxide composite ultrasonically in a mixed solvent of anhydrous ethanol and water, and then adding acetic acid to adjust the pH value of the system to 4-6 to obtain a mixed solution B.

Furthermore, a preparation method for a thiol-functionalized magnetic oxygenous carbon nitride nanosheet: 2, preparation of the thiol-functionalized magnetic oxygenous carbon nitride nanosheet: the mass volume ratio of the magnetic carbon nitride oxide composite described in Step S1 to the mixed solvent is 3-5 mg/mL; the volume ratio of anhydrous ethanol and water is (1-1.5):1.

Furthermore, a preparation method for a thiol-functionalized magnetic oxygenous carbon nitride nanosheet: 2, preparation of the thiol-functionalized magnetic oxygenous carbon nitride nanosheet: Step S2, adding a thiol-rich modifier to mixed solution B, and modifying the magnetic carbon nitride oxide composite for 15-25 hours; after modification, separating the magnetic carbon nitride oxide composite from the solution by a magnet and cleaning by ultrapure water and ethanol for 3-5 times respectively to obtain a thiol-functionalized magnetic oxygenous carbon nitride nanosheet;
among them: the temperature of the solution during the modification is maintained at 35-45° C.; the thiol-rich modifier is 3-mercaptopropyltrimethoxysilane (MPTS).

An application of a thiol-functionalized magnetic oxygenous carbon nitride nanosheet is characterized by the application of the thiol-functionalized magnetic oxygenous carbon nitride nanosheet prepared by the above preparation method in the adsorption of heavy metal ions.

Furthermore, the application of a thiol-functionalized magnetic oxygenous carbon nitride nanosheet: the application of the thiol-functionalized magnetic oxygenous carbon nitride nanosheet in the adsorption of heavy metal ions is as follows:
(1) putting the thiol-functionalized magnetic oxygenous carbon nitride nanosheet into a solution containing heavy metal ions, and adjusting the pH value of the system to oscillate and adsorb at room temperature;
(2) after adsorption, separating the thiol-functionalized magnetic oxygenous carbon nitride nanosheet from the solution by a magnet.

The surface of the thiol-functionalized magnetic oxygenous carbon nitride nanosheet (CNO/Fe₃O₄—SH) prepared by the invention contains abundant groups, such as —NH₂, —OH, —SH, and —COOH. The thiol-functionalized magnetic oxygenous carbon nitride nanosheet prepared by the invention has a good adsorption effect on heavy metal ions, and the thiol-functionalized magnetic oxygenous carbon nitride nanosheet adsorbed with heavy metal ions can be placed in hydrochloric acid and potassium hydroxide solution to desorb the heavy metal ions (such as Pb²⁺, As³⁺, and Cd²⁺), thereby realizing the reuse of the thiol-functionalized magnetic oxygenous carbon nitride nanosheet. The nanosheet can still maintain high adsorption performance and initial morphology after repeated use six times.

The beneficial effects of the invention are as follows:
(1) The preparation process of the thiol-functionalized magnetic oxygenous carbon nitride nanosheets provided by the invention is relatively simple, and the prepared nanosheets (CNO/Fe₃O₄—SH) have the advantages of high adsorption efficiency, excellent repeatability, reproducibility and easy separation for heavy metal ions, which can be widely used in the removal of heavy metal ions in actual water samples.
(2) The thiol-functionalized magnetic oxygenous carbon nitride nanosheet prepared by the method of this invention contains a large number of active functional groups on the surface, which have the advantages of a large specific surface area and easy preparation.
(3) For the first time, a new thiol-functionalized magnetic oxygenous carbon nitride nanosheet is applied to the adsorption of heavy metal ions, which can remove lead, arsenic, and cadmium in aqueous solution, the new thiol-functionalized magnetic oxygenous carbon nitride nanosheet prepared by the invention can simultaneously and efficiently adsorb lead, arsenic, and cadmium in water, and has magnetic recyclability, which has great potential application value in the field of water pollution treatment.

### BRIEF DESCRIPTION OF THE DRAWINGS

In order to more clearly explain the technical solution of the embodiment of the invention, the following will briefly introduce the drawings needed to be used in the description of the embodiment. Obviously, the drawings in the following description are only some examples of the invention, for the technical personnel in this field, other drawings can be obtained according to these drawings without paying creative labor.

FIG. 1 is a transmission electron microscope image of the thiol-functionalized magnetic oxygenous carbon nitride nanosheets prepared by Example 1 of the invention.

FIG. 2 is the hysteresis curves of Fe₃O₄, CNO/Fe₃O₄, and CNO/Fe₃O₄—SH nanosheets.

FIG. 3 is the effect diagram of different pH values on the adsorption of heavy metal ions by the thiol-functionalized magnetic oxygenous carbon nitride nanosheet.

FIG. 4 is the Langmuir and Freundlich adsorption isotherms of Pb²⁺, As³⁺, and Cd²⁺ on the thiol-functionalized magnetic oxygenous carbon nitride nanosheet.

### DETAILED DESCRIPTION OF THE EMBODIMENTS

The following will be combined with the drawings of the embodiment of the invention to clearly and completely describe the technical solution of the embodiment of the invention. Obviously, the described embodiment is only a part of the embodiment of the invention, not the whole embodiment. The following description of at least one exemplary embodiment is actually only illustrative and in no way serves as any restriction on the invention and its application or use. Based on the embodiments in this invention, all other embodiments obtained by ordinary technicians in this field without making creative labor belong to the scope of protection of this invention.

### Example 1

A preparation method for a thiol-functionalized magnetic oxygenous carbon nitride nanosheet included the following specific steps:
1. preparation of the magnetic carbon nitride oxide composites:
S1, after 1.0 g carbon nitride (CNO) was added to 25.0 mL deionized water for ultrasonic dispersion for 5 hours, a carbon nitride suspension was obtained;
S2, 1.0 g iron source was dissolved in 12.0 mL ultrapure water at room temperature to form a solution; then all the solution was added into the carbon nitride oxide suspension to obtain a mixed solution A; among them, the iron source was a mixture of FeCl₃·6H₂O and FeCl₂·4H₂O with a molar ratio of 2:1;
S3, the mixed solution A was heated in a water bath at 80° C. for 5 minutes, then ammonia was added quickly to adjust the pH value of the reaction system to 10, and the stirring reaction was continued for 30 minutes, the sediment was separated and washed and dried at 60° C. for 24 hours to obtain a magnetic carbon nitride oxide composite (CNO/Fe₃O₄) after cooling.
2. Preparation of the thiol-functionalized magnetic oxygenous carbon nitride nanosheet:
S1, 0.2 g magnetic carbon nitride oxide composite was ultrasonically dispersed in a mixed solvent composed of 25.0 mL anhydrous ethanol and 20.0 mL water, and then acetic acid (CH₃COOH) was added to adjust the pH to 5.0 to obtain a mixed solution B;
S2, 5.0 mL 3-mercaptopropyltrimethoxysilane (MPTS) was added to the above-mixed solution B, and the magnetic carbon nitride complex in the solution was modified at 40° C. for 24 hours. After modification, the magnetic carbon nitride oxide composite was separated from the solution by a magnet and washed three times with ultrapure water and ethanol respectively to obtain a thiol-functionalized magnetic oxygenous carbon nitride nanosheet (CNO/Fe₃O₄—SH).

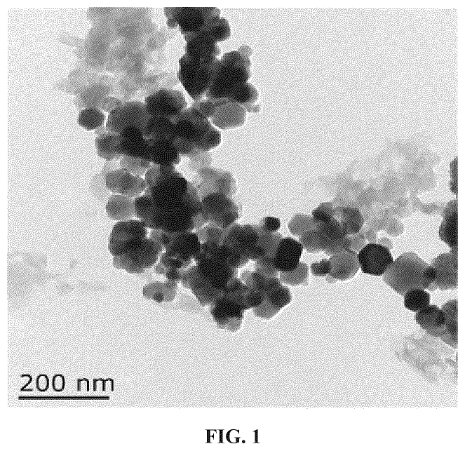

The morphology of the thiol-functionalized magnetic oxygenous carbon nitride nanosheet prepared by the above Example 1 was observed by transmission electron microscopy. As shown in FIG. 1, it can be clearly seen from this figure that the black granular Fe₃O₄ was modified on the translucent graphite oxide phase carbon nitride, and after the thiol-functionalization, the morphology and structure of the magnetic carbon nitride oxide composites did not change significantly, indicating that the thiol-functionalized magnetic oxygenous carbon nitride nanosheet was successfully synthesized.

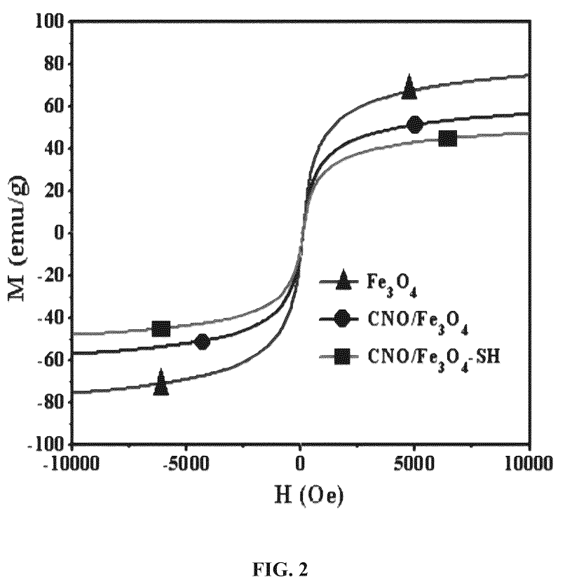

The magnetic properties of thiol-functionalized magnetic oxygenous carbon nitride nanosheet (CNO/Fe₃O₄—SH), magnetic oxygenous carbon nitride nanosheets (CNO/Fe₃O₄) and Fe₃O₄ prepared in embodiment 1 were characterized by vibrating sample magnetometer, the results are shown in FIG. 2, it can be seen clearly from this figure that there was no obvious hysteresis phenomenon in the hysteresis curves of Fe₃O₄, CNO/Fe₃O₄ and CNO/Fe₃O₄—SH nanosheets, and their saturation magnetic intensities were 75.4 emu/g, 57.5 emu/g, and 48.8 emu/g respectively; the results showed that the CNO/Fe₃O₄—SH nanosheet prepared by the invention had a relatively large saturation magnetic strength.

Application:

The thiol-functionalized magnetic oxygenous carbon nitride nanosheets prepared by the above Embodiment 1 were used to adsorb heavy metal ions (including lead, arsenic, and cadmium ions) in water, the specific process is as follows.
(1) 10 mg thiol-functionalized magnetic oxygenous carbon nitride nanosheet was put into 100 mL heavy metal ion solution, the pH value of the solution system was adjusted to 2-10 by adding a small amount of hydrochloric acid and sodium hydroxide, and then the adsorption was carried out at room temperature at a speed of 150 r/min for 12 hours;
(2) after adsorption, the above-mentioned thiol-functionalized magnetic oxygenous carbon nitride nanosheet was separated from the solution by a magnet.

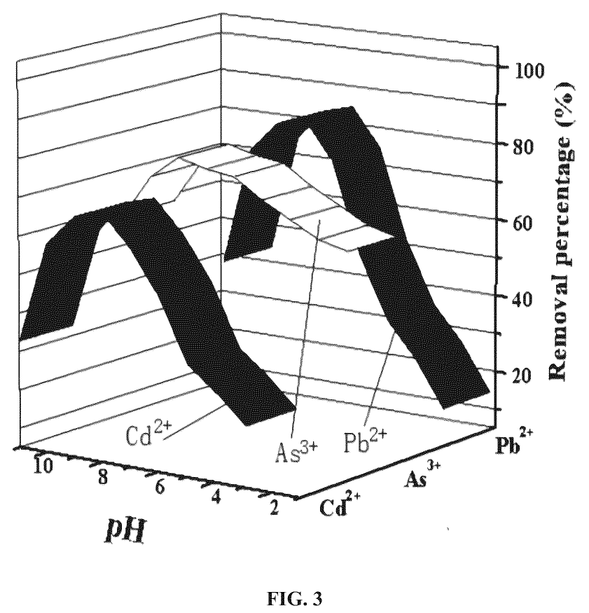

After the separation of the thiol-functionalized magnetic oxygenous carbon nitride nanosheet, the concentration of heavy metal ions in the solution was analyzed by an inductively coupled plasma mass spectrometry (ICP-MS) or an inductively coupled plasma optical emission spectrometer (ICP-OES), the results were shown in FIG. 3. (The calculation formula of adsorption capacity was as follows:

$${q}_{t} = \frac{( {C}_{0} - {C}_{t} ) * V}{M}$$

in this equation, C₀ and Cₜ represented the initial concentration and the concentration at time t, respectively.

FIG. 3 showed the adsorption of lead, arsenic, and cadmium by CNO/Fe₃O₄—SH composites under different initial pH conditions (pH=2-10), it can be seen from FIG. 3 that the adsorption capacity of CNO/Fe₃O₄—SH composites for lead and cadmium is low at a lower pH value. With the increase of pH, the adsorption capacity of CNO/Fe₃O₄—SH composites for lead and cadmium gradually increased, this is because when the pH value was low, the concentration of H⁺ in the metal solution was large, and the H⁺ in the solution competed with the heavy metal ions during the adsorption process, which reduced the adsorption capacity of CNO/Fe₃O₄—SH composites for lead (Pb²⁺) and cadmium (Cd²⁺) ions. At the same time, under lower pH conditions, the positively charged hydrogen ions and the functional groups on the surface of the composite material (CNO/Fe₃O₄—SH) combined to compete with the metal ions to adsorb; once the functional group was protonated, strong electrostatic repulsion would prevent metal ions from contacting the surface of the adsorbent. With the increase in pH value, the concentration of H⁺ gradually decreased, the competition between H⁺ and heavy metal ions weakened, the effective sites of CNO/Fe₃O₄—SH composites increased, and the adsorption capacity gradually increased. However, the high pH value caused the excessive concentration of OH⁻ in the solution, which affected the ion morphology of lead and cadmium in the solution, thus affecting the adsorption effect. Compared with the adsorption of Pb²⁺ and Cd²⁺ by the CNO/Fe₃O₄—SH composite, the pH value of the system had little effect on the adsorption of arsenic (As³⁺) by the composite, indicating that arsenic ions on the adsorbent had different adsorption mechanisms with the other two kinds of ions. In the range of pH=4-6, arsenic coexisted in the form of H₃AsO₃ and H₂AsO₃⁻, and existed in the form of various anions at pH>7. Therefore, the adsorption of the CNO/Fe₃O₄—SH nanosheet under alkaline conditions was mainly through the specific adsorption of the coordination complexation at pH<7. In summary, the neutral acidic solution environment was more conducive to the adsorption of the CNO/Fe₃O₄—SH nanosheet.

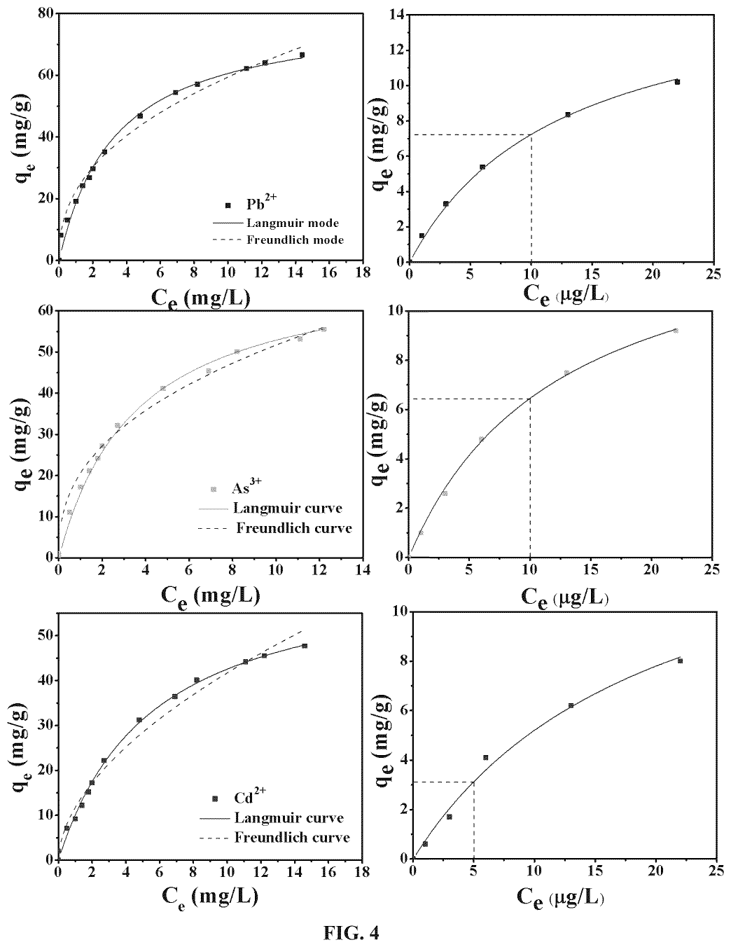

FIG. 4 was the Langmuir and Freundlich adsorption isotherms of Pb²⁺, As³⁺, and Cd²⁺ on the thiol-functionalized magnetic oxygenous carbon nitride nanosheet prepared by Example 1 of the invention, the parameters obtained by fitting the Langmuir and Freundlich models were shown in Table 1:

It can be seen from Table 1 that the Langmuir model can describe the experimental data of Pb²⁺, As³⁺, and Cd²⁺ adsorption by the CNO/Fe₃O₄—SH nanosheet clearly, where R²>0.98, indicating that the adsorptions of Pb²⁺, As³⁺, and Cd²⁺ by the CNO/Fe₃O₄—SH nanosheet belonged to the single molecule adsorption. The saturated adsorption capacities of CNO/Fe₃O₄—SH nanosheets for Pb²⁺, As³⁺, and Cd²⁺ were 80.79 mg/g, 71.78 mg/g, and 66.19 mg/g, respectively. In addition, it can be seen from the kL values in Table 1 between 0 and 1 that the CNO/Fe₃O₄—SH nanosheets had a high adsorption removal capacity for Pb²⁺, As³⁺, and Cd²⁺. Because n was greater than 1 in Table 1, CNO/Fe₃O₄—SH nanosheets were beneficial to the adsorption of heavy metal ions. This was because the thiol-modified magnetic carbon nitride had more active functional groups, which acted as active sites to adsorb heavy metal ions and improved its adsorption capacity.

Table 1 was the Langmuir and Freundlich model fitting parameters of the adsorption of Pb²⁺, As³⁺, and Cd²⁺ by the thiol-functionalized magnetic oxygenous carbon nitride nanosheet:

| | Langmuir | | | Freundlich | | |
|---|---|---|---|---|---|---|
| Metal ion | k_{L}/(L/mg) | qₘₐₓ/(mg/g) | R² | k_{F} | n | R² |
| Pb²⁺ | 0.32 | 80.79 | 0.991 | 22.59 | 2.38 | 0.986 |
| As³⁺ | 0.28 | 71.778 | 0.995 | 20.57 | 2.51 | 0.981 |
| Ca²⁺ | 0.18 | 66.188 | 0.997 | 11.75 | 1.82 | 0.982 |

Note: The qₘₐₓ in the table was the Langmuir saturated adsorption capacity (mg/g), and K_{L} was the Langmuir equilibrium constant (L/mg), which was related to the affinity of the adsorbent binding site; k_{F} and n represented Freundlich constants; R² is the fitting degree, which referred to the fitting degree of the regression line to the observed value, and the maximum value of R² was 1; when the value of R² was closer to 1, the fitting degree of the regression line to the observed value would be better. On the contrary, when the value of R² was smaller, the fitting degree of the regression line to the observed value would become worse.

The n value was often used to judge the preferential adsorption, when n>1, it was the preferential adsorption; when n=1, it was the linear adsorption; when n<1, it was the non-preferential adsorption, that was to say, when n was greater than 1, the adsorbent was suitable for the adsorption of these metal ions.

The above-mentioned is a better embodiment of the invention which is only used to explain the invention and is not used to limit the invention. Any obvious changes or amendments extended by the technical solution of the invention are still within the protection scope of the invention.

What is claimed is:

1. A preparation method for a thiol-functionalized magnetic oxygenous carbon nitride nanosheet, comprising the following steps:
preparation of a magnetic carbon nitride oxide composite:
S1, dispersing carbon nitride oxide ultrasonically to obtain a carbon nitride oxide suspension;
S2, dissolving an iron source, and then adding the iron source to the carbon nitride oxide suspension to obtain a first mixed solution; wherein the iron source contains divalent iron and trivalent iron; and
S3, after a hydrothermal reaction of the first mixed solution, adjusting a pH value of a reaction system to be alkaline, and then cooling, separating a sediment, washing, and drying to obtain the magnetic carbon nitride oxide composite; and
preparation for the thiol-functionalized magnetic oxygenous carbon nitride nanosheet:
S1, dispersing the magnetic carbon nitride oxide composite ultrasonically in a solvent, and then adding acid to adjust a pH to be acidic to obtain a second mixed solution; and
S2, adding a thiol-rich modifier to the second mixed solution to modify the magnetic carbon nitride oxide composite to obtain a resulting solution; after modification, separating and washing the magnetic carbon nitride oxide composite from the resulting solution to obtain the thiol-functionalized magnetic oxygenous carbon nitride nanosheet.

2. The preparation method according to claim 1, wherein the preparation of the magnetic carbon nitride oxide composite comprises: step S1, adding the carbon nitride oxide to deionized water and dispersing ultrasonically for 3 hours-5 hours to obtain the carbon nitride oxide suspension; wherein a mass volume ratio of the carbon nitride oxide to the deionized water is 20 mg/mL-60 mg/mL.

3. The preparation method according to claim 1, wherein the preparation of the magnetic carbon nitride oxide composite comprises: step S2, dissolving the iron source in ultrapure water at room temperature to form a solution; then, adding the solution into the carbon nitride oxide suspension to obtain the first mixed solution; wherein the iron source is a mixture of ferric chloride hexahydrate and ferrous chloride tetrahydrate.

4. The preparation method according to claim 3, wherein in the preparation of the magnetic carbon nitride oxide composite, a mass volume ratio of the iron source to the ultrapure water in step S2 is 50 mg/mL-100 mg/mL; a volume ratio of the solution to the carbon nitride oxide suspension is 1:(2-5); and a molar ratio of the ferric chloride hexahydrate to the ferrous chloride tetrahydrate is (1-3):1.

5. The preparation method according to claim 1, wherein the preparation of the magnetic carbon oxide composite further comprises: step S3, placing the first mixed solution in a water bath pot at 70° C.-90° C. for 3 minutes-5 minutes, and then adding ammonia water quickly to adjust the pH value of the reaction system to 9-11, and then stirring reaction for 20 minutes-40 minutes, then cooling, separating and washing the sediment, drying at 50° C.-70° C. for 12 hours-24 hours to obtain the magnetic carbon oxide composite.

6. The preparation method according to claim 1, wherein the preparation of the thiol-functionalized magnetic oxygenous carbon nitride nanosheet comprises: step S1, dispersing the magnetic carbon nitride oxide composite ultrasonically in a mixed solvent of anhydrous ethanol and water and then adding acetic acid to adjust a pH value of a system to 4-6 to obtain the second mixed solution.

7. The preparation method according to claim 6, wherein in the preparation of the thiol-functionalized magnetic oxygenous carbon nitride nanosheet, a mass volume ratio of the magnetic carbon nitride oxide composite in step S1 to the mixed solvent is 3 mg/mL-5 mg/mL; and a volume ratio of the anhydrous ethanol and the water is (1-1.5):1.

8. The preparation method according to claim 1, wherein the preparation of the thiol-functionalized magnetic oxygenous carbon nitride nanosheet comprises: step S2, adding the thiol-rich modifier to the second mixed solution to modify the magnetic carbon nitride oxide composite for 15 hours-25 hours to obtain the resulting solution; after modification, separating the magnetic carbon nitride oxide composite from the resulting solution by a magnet and cleaning by ultrapure water and ethanol for 3 times-5 times respectively to obtain the thiol-functionalized magnetic oxygenous carbon nitride nanosheet;
wherein a temperature of the resulting solution during the modification is maintained at 35° C.-45° C.; and the thiol-rich modifier is 3-mercaptopropyltrimethoxysilane (MPTS).

9. A method of applying a thiol-functionalized magnetic oxygenous carbon nitride nanosheet, comprising: applying the thiol-functionalized magnetic oxygenous carbon nitride nanosheet prepared by the preparation method according to claim 1 in adsorption of heavy metal ions.

10. The method according to claim 9, wherein the step of applying the thiol-functionalized magnetic oxygenous carbon nitride nanosheet in the adsorption of heavy metal ions comprises:
(1) putting the thiol-functionalized magnetic oxygenous carbon nitride nanosheet into a solution containing the heavy metal ions, and adjusting a pH value of a system to oscillate and adsorb at room temperature; and
(2) after adsorption, separating the thiol-functionalized magnetic oxygenous carbon nitride nanosheet from the solution by a magnet.

11. The method according to claim 9, wherein in the preparation method, the preparation of the magnetic carbon nitride oxide composite comprises: step S1, adding the carbon nitride oxide to deionized water and dispersing ultrasonically for 3 hours-5 hours to obtain the carbon nitride oxide suspension; wherein a mass volume ratio of the carbon nitride oxide to the deionized water is 20 mg/mL-60 mg/mL.

12. The method according to claim 9, wherein in the preparation method, the preparation of the magnetic carbon nitride oxide composite comprises: step S2, dissolving the iron source in ultrapure water at room temperature to form a solution; then, adding the solution into the carbon nitride oxide suspension to obtain the first mixed solution; wherein the iron source is a mixture of ferric chloride hexahydrate and ferrous chloride tetrahydrate.

13. The method according to claim 12, wherein in the preparation method, in the preparation of the magnetic carbon nitride oxide composite, a mass volume ratio of the iron source to the ultrapure water in step S2 is 50 mg/mL-100 mg/mL; a volume ratio of the solution to the carbon nitride oxide suspension is 1:(2-5); and a molar ratio of the ferric chloride hexahydrate to the ferrous chloride tetrahydrate is (1-3):1.

14. The method according to claim 9, wherein in the preparation method, the preparation of the magnetic carbon oxide composite further comprises: step S3, placing the first mixed solution in a water bath pot at 70° C.-90° C. for 3 minutes-5 minutes, and then adding ammonia water quickly to adjust the pH value of the reaction system to 9-11, and then stirring reaction for 20 minutes-40 minutes, then cooling, separating and washing the sediment, drying at 50° C.-70° C. for 12 hours-24 hours to obtain the magnetic carbon oxide composite.

15. The method according to claim 9, wherein in the preparation method, the preparation of the thiol-functionalized magnetic oxygenous carbon nitride nanosheet comprises: step S1, dispersing the magnetic carbon nitride oxide composite ultrasonically in a mixed solvent of anhydrous ethanol and water and then adding acetic acid to adjust a pH value of a system to 4-6 to obtain the second mixed solution.

16. The method according to claim 15, wherein in the preparation method, in the preparation of the thiol-functionalized magnetic oxygenous carbon nitride nanosheet, a mass volume ratio of the magnetic carbon nitride oxide composite in step S1 to the mixed solvent is 3 mg/mL-5 mg/mL; and a volume ratio of the anhydrous ethanol and the water is (1-1.5):1.

17. The method according to claim 9, wherein in the preparation method, the preparation of the thiol-functionalized magnetic oxygenous carbon nitride nanosheet comprises: step S2, adding the thiol-rich modifier to the second mixed solution to modify the magnetic carbon nitride oxide composite for 15 hours-25 hours to obtain the resulting solution; after modification, separating the magnetic carbon nitride oxide composite from the resulting solution by a magnet and cleaning by ultrapure water and ethanol for 3 times-5 times respectively to obtain the thiol-functionalized magnetic oxygenous carbon nitride nanosheet;
wherein a temperature of the resulting solution during the modification is maintained at 35° C.-45° C.; and the thiol-rich modifier is 3-mercaptopropyltrimethoxysilane (MPTS).
